(19) United States
(12) Patent Application Publication
(10) Pub. No.: US 2018/0206452 A1
(43) Pub. Date: Jul. 26, 2018

(54) PET TOY

(71) Applicant: Chia-Sheng LAI, Taipei City (TW)

(72) Inventor: Chia-Sheng LAI, Taipei City (TW)

(21) Appl. No.: 15/411,594

(22) Filed: Jan. 20, 2017

(51) Int. Cl. A01K 15/02

(52) U.S. Cl. CPC A01K 15/025

(57) ABSTRACT

A pet toy has a body and a lid. The body has an accommodating space and an opening. The accommodating space is formed inside the body, and the opening is formed on an outer surface of the body and communicates with the accommodating space. The lid is detachably mounted on the opening. Therefore, the accommodating space of the pet toy is capable of containing an odor element, and thereby the pet toy can keep emitting smell and tempting pets. In other words, the pet can play the pet toy with appeal in both vision and smell.

### BACKGROUND OF THE INVENTION

### 1. Field of the Invention

The present invention relates to a toy, especially to a toy for pets.

### 2. Description of the Prior Arts

Human beings need to participate in leisure activities, such as sports or video games, for relaxing and releasing pressure. Similarly, pets also confront pressure and need to relax. Therefore, many toys are designed for pets, and those toys, i.e., the pet toys, have colorful appearances, elegant shapes, or funny characters. However, those designs only can attract consumers but cannot attract pets, so many people have the frustrating experience that their carefully selected pet toys do not attract the pet's interest at all. In fact, animals, unlike human beings, rely more on smell rather than vision, and hence the pet toys designed with special profiles in visual appeal are useless.

To overcome the shortcomings, the present invention provides a pet toy to mitigate or obviate the aforementioned problems.

### SUMMARY OF THE INVENTION

The main objective of the present invention is to provide a pet toy that attracts pets through both visual and olfactory perceptions.

The pet toy has:

a body comprising:
an accommodating space formed inside the body; and
an opening formed on an outer surface of the body and communicating with the accommodating space;

a lid detachably mounted on the opening; and

an odor element arranged in the accommodating space.

The pet toy of the present invention has an accommodating space for containing an odor element, and thereby the pet toy can keep emitting smell and tempting pets. In other words, the pet can play with the pet toy with appeal in both vision and smell.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pet toy in accordance with the present invention;

FIG. 2 is an exploded perspective view of the pet toy in FIG. 1; and

FIG. 3 is a cross-sectional view of the pet toy in FIG. 1.

### DETAILED DESCRIPTION OF THE PREFERRED EMBODIMENTS

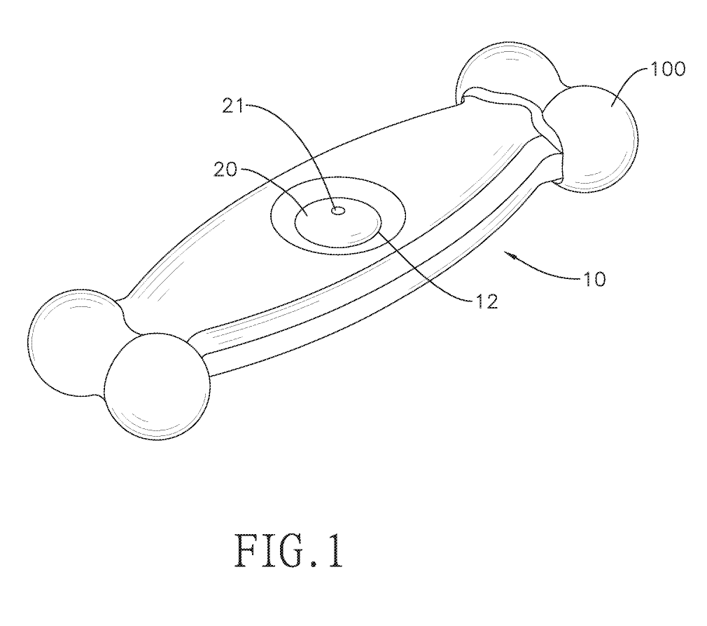

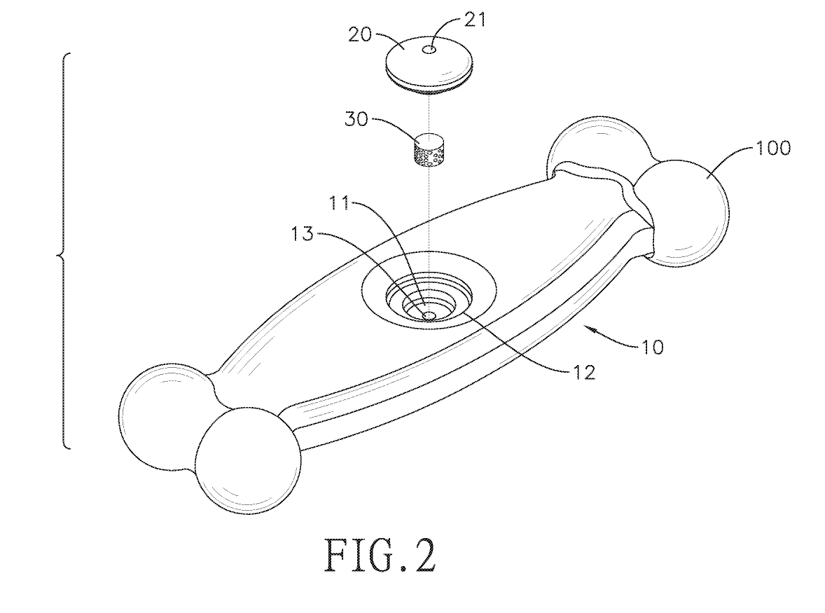

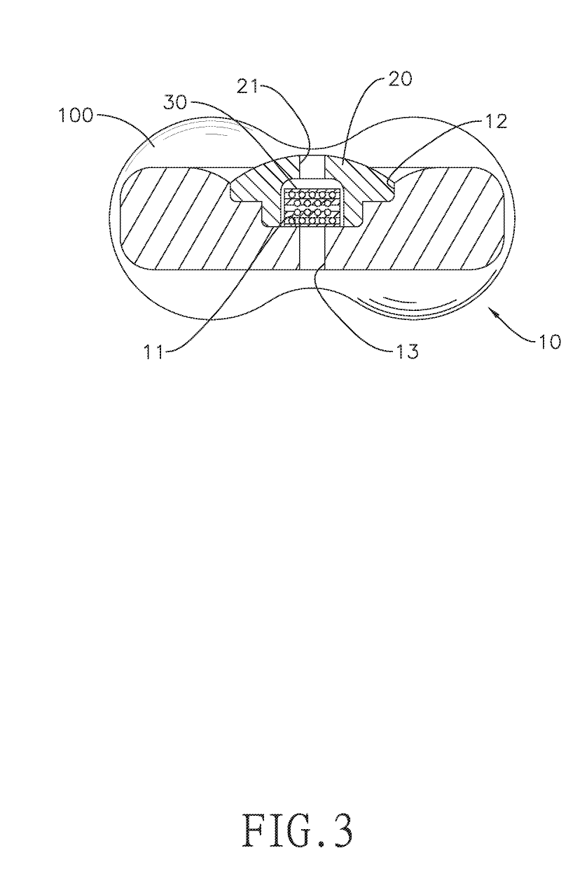

With reference to FIGS. 1 to 3, a pet toy in accordance with the present invention comprises a body 10, a lid 20, and an odor piece 30.

The body 10 is a short stick with two ends, and each end of the body 10 has two balls 100 juxtaposed to each other at the end of the body 10. In other words, a shape of the body 10 is similar to a bone.

The body 10 comprises an accommodating space 11, an opening 12, and at least one first through hole 13. The accommodating space 11 is formed inside the body 10, and the opening 12 is formed on an outer surface of the body 10 and communicates with the accommodating space 11. The at least one first through hole 13 is formed on the outer surface of the body 10 and opposite the opening 12, and the first through hole 13 communicates with the accommodating space 11. In this embodiment, a number of the first through hole 13 is one.

The lid 20 is detachably mounted on the opening 12 and selectively covers the accommodating space 11. The lid 20 comprises at least one second through hole 21 formed through the lid 20 and communicating with the accommodating space 11. In this embodiment, a number of the second through hole 21 is one.

With the aforesaid structure, a pet's owner can put an odor element 30 in the accommodating space 11 of the body 10. The odor piece 30 is an object which can emit smell pets liked. Therefore, when a smell of the odor element 30 leaks from a seam between the opening 12 and the lid 20, the first through hole 13 of the body 10, or the second through hole 21 of the lid 20, the pet toy can attract pets by the emitted smell. Besides, with the smell, even the pet's owner hides the pet toy out of the pet's sight, the pet toy still keeps tempting the pet to find it, and thereby the pet may explore the environment and track the pet toy, adding variety and entertainment to the play.

Consequently, the pet toy has the accommodating space 11 for containing an odor element 30, and thereby the pet toy can keep emitting smell and tempting pets. In other words, the pet can play with the pet toy with appeal in both vision and smell.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pet toy comprising:
a body comprising:
an accommodating space formed inside the body; and
an opening formed on an outer surface of the body and communicating with the accommodating space;
a lid detachably mounted on the opening; and
an odor element arranged in the accommodating space.

2. The pet toy as claimed in claim 1, wherein the lid comprises a through hole communicating with the accommodating space.

3. The pet toy as claimed in claim 1, wherein the body comprises a through hole communicating with the accommodating space.

4. The pet toy as claimed in claim 2, wherein the body comprises a through hole communicating with the accommodating space.

5. The pet toy as claimed in claim 1, wherein the body comprises two ends and each end comprises:
two balls juxtaposed to each other at the end of the body.

6. The pet toy as claimed in claim 2, wherein the body comprises two ends and each end comprises:
two balls juxtaposed to each other at the end of the body.

7. The pet toy as claimed in claim 4, wherein the body comprises two ends and each end comprises:
two balls juxtaposed to each other at the end of the body.
